(19) United States
(12) Patent Application Publication
(10) Pub. No.: US 2026/0103936 A1
(43) Pub. Date: Apr. 16, 2026

(54) DOOR DRIVING UNIT AND VEHICLE INCLUDING THE SAME

(71) Applicants: Hyundai Motor Company, Seoul (KR); Kia Corporation, Seoul (KR); PHA Co., Ltd., Daegu (KR)

(72) Inventors: Duck Young Kim, Hwaseong-si (KR); Geon Hee Lee, Hwaseong-si (KR); Doo Jung Kim, Daegu (KR); Seong Tae Hong, Daegu (KR)

(21) Appl. No.: 19/098,140

(22) Filed: Apr. 2, 2025

(30) Foreign Application Priority Data
Oct. 10, 2024 (KR) 10-2024-0137843

(51) Int. Cl. E05F 15/614

(52) U.S. Cl. CPC E05F 15/614; E05Y 2600/524; E05Y 2600/526; E05Y 2900/544

(57) ABSTRACT

A door driving system can include a first bracket, a second bracket, a hinge portion connecting the first bracket to the second bracket, a driving portion disposed on the first bracket and coupled to the hinge portion, and a connecting portion having one side coupled to the second bracket and the other side connected to the driving portion to support rotation of the first bracket.

### CROSS-REFERENCE TO RELATED APPLICATIONS

This application claims benefit of priority to Korean Patent Application No. 10-2024-0137843 filed on Oct. 10, 2024 in the Korean Intellectual Property Office, the disclosure of which is incorporated herein by reference in its entirety.

### TECHNICAL FIELD

The present disclosure relates to a door driving unit and a vehicle including the same.

### BACKGROUND

Vehicles are provided with a space for passengers to board and a space for loading luggage. Here, the space for loading luggage is usually referred to as a trunk, and the trunk is commonly provided at the rear of a vehicle. Recently, however, electric vehicles with a modular structure have been proposed, in which case, a trunk may be placed at the front as well as at the rear of a vehicle.

A door may be disposed over the trunk. The door disposed over the trunk may be a way for distinguishing between the interior and exterior of the trunk.

A door disposed over the trunk may include a lift gate opened upwardly with respect to the vehicle and a tail gate opened downwardly with respect to the vehicle.

Recently, for the convenience of users, doors have been opened and closed electrically through a door driving unit. In this case, due to restrictions on the structure of the door driving unit and the placement position according to the structure of the door driving unit, interference may occur between a body and the door when the door is opened, and accordingly, there may be a problem that an opening angle of the door is limited. In addition, the loading space is reduced because a portion of the loading space of the trunk is used as a space for disposing a driving portion of the door driving unit.

### SUMMARY

An embodiment of the present disclosure can provide a door driving unit in which an opening range of a door is maximized and a driving portion may be disposed to be adjacent to the door, thereby maximizing a loading space of a trunk.

An advantage of an embodiment of the present disclosure is not necessarily limited to the advantage mentioned above, and other advantages not mentioned may be understood by those skilled in the art to which the present disclosure pertains from the description below.

According to an embodiment of the present disclosure, a door driving unit can include: a first bracket; a second bracket; a hinge portion connecting the first bracket to the second bracket; a driving portion disposed on the first bracket and coupled to the hinge portion; and a connecting portion having one side coupled to the second bracket and the other side connected to the driving portion to support rotation of the first bracket.

The first bracket may include: a first plate; a second plate connected to the second bracket through the hinge portion; and an extension portion connecting the first plate to the second plate, wherein the driving portion may be coupled to the second plate.

The first plate and the second plate may be disposed in an intersecting direction.

The first bracket may be provided with a first coupling portion connected to the hinge portion, and the first coupling portion may be disposed to be spaced apart from the connecting portion in a direction of a rotational axis of the hinge portion.

The driving portion may include a power shaft transmitting rotation power, one side of the hinge portion may be coupled to the power shaft and the other side of the hinge portion may be coupled to the second bracket, and the second bracket may rotate by the rotation of the hinge portion.

The connecting portion may be provided with a hole through which the power shaft passes, and a clearance may be formed between an inner circumferential surface of the hole and an outer circumferential surface of the power shaft.

The power shaft and the hinge portion may be forcedly fitted to be coupled.

An adhesive may be applied between the power shaft and the hinge portion.

According to an embodiment of the present disclosure, a vehicle can include: a body; a door disposed on the body; and a door driving unit driving the door, wherein the door driving unit can include a first bracket, a second bracket, a hinge portion connecting the first bracket to the second bracket, and a driving portion disposed on the first bracket and coupled to the hinge portion. The door driving unit can further include a connecting portion having one side coupled to the second bracket and the other side connected with the driving portion to support rotation of the first bracket.

The first bracket may be coupled to the door, and the second bracket may be coupled to the body.

The first bracket may include: a first plate; a second plate connected to the second bracket through the hinge portion; and an extension portion connecting the first plate to the second plate; where the first plate and the second plate may be spaced apart in a direction of a rotational axis of the hinge portion and are coupled to the door.

The first plate and the second plate may be disposed in an intersecting direction and are each coupled to the door.

The vehicle may further include a link portion connecting the body and the door, where the link portion may be disposed to be spaced apart from the door driving unit in a width direction of the body.

### BRIEF DESCRIPTION OF THE DRAWINGS

The features and advantages of example embodiments of the present disclosure can be more clearly understood from the following detailed description, taken in conjunction with the accompanying drawings, in which:

FIG. 1 is a diagram illustrating the rear of a vehicle to which a door driving unit is applied according to an embodiment of the present disclosure;

FIG. 2 is a perspective view of a door driving unit according to an embodiment of the present disclosure;

FIG. 3 is an exploded view of FIG. 2;

FIG. 4 is a plan view of a door driving unit according to an embodiment of the present disclosure;

FIGS. 5A and 5B are diagrams illustrating an operation of a door driving unit according to an embodiment of the present disclosure;

FIG. 6 is a cross-sectional view taken along line A-A′ of FIG. 4;

FIG. 7 is a perspective view illustrating a first bracket of a door driving unit according to an embodiment of the present disclosure;

FIG. 8 is a perspective view illustrating a second bracket of a door driving unit according to an embodiment of the present disclosure;

FIG. 9 is an exploded view of the second bracket of FIG. 8; and

FIG. 10 is a perspective view illustrating a link portion that may be used with a door driving unit according to an embodiment of the present disclosure.

### DETAILED DESCRIPTION OF ILLUSTRATIVE EMBODIMENTS

While embodiments of the present disclosure may be modified in various ways and take on various alternative forms, specific example embodiments are shown in the drawings and described in detail below. However, it can be understood that there is no intent to necessarily limit the present disclosure to the particular forms disclosed, but on the contrary, the present disclosure can cover modifications, equivalents, and alternatives for embodiments falling within the spirit and scopes of the present disclosure.

It can be understood that, although the terms “first,” “second,” etc. may be used herein to describe various elements, these elements are not necessarily limited by these terms. These terms can be used merely to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be necessarily limited by these terms. The terms may refer to not only physically/visually distinct components, but also to functions or components of a portion even if the corresponding portion is not clearly divided.

The terms used herein to describe example embodiments of the present disclosure are not intended to necessarily limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It can be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, terms used herein including technical and scientific terms can have same meanings as understood by those skilled in the art to which the present disclosure pertains. Such terms as defined in generally used dictionaries can be construed to have same meanings as those of the contexts of the related art.

In this specification, vehicles can refer to a variety of vehicles that move transported objects, such as people, animals, or goods, from a starting point to a destination. These vehicles are not limited to vehicles that run on roads or tracks. Vehicles can include not only those that use fossil fuels, such as gasoline, but also those that use electricity stored in batteries or the like and those that use future fuels, such as hydrogen.

In the description below, the terms “anterior,” “posterior,” “lateral,” “front,” “rear,” “up/down,” “above,” “upper,” “top,” “below” “lower” “bottom” “left/right” and the like are defined based on a vehicle or body. Terms, such as “first” and “second” may be used to describe various components, but these components are not necessarily limited in order, size, location, or importance by terms, such as first and second and named for the sole purpose of distinguishing one component from another.

Example embodiments of the present disclosure are described in detail with reference to the accompanying drawings.

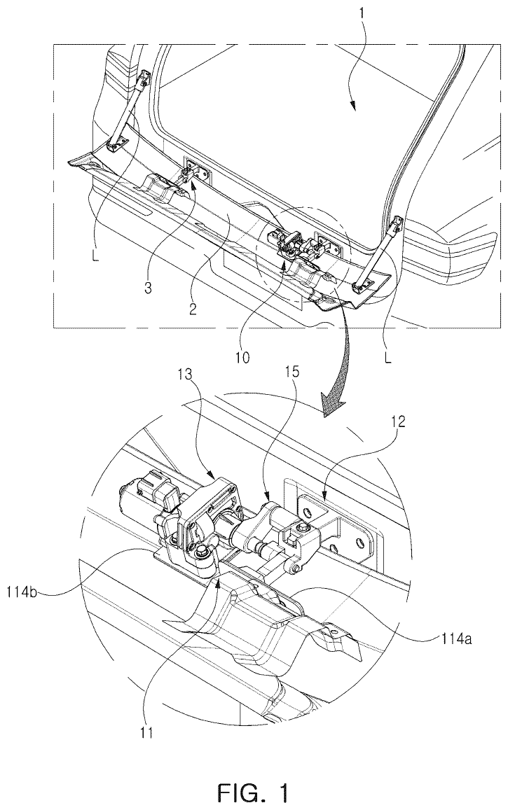

FIG. 1 is a diagram illustrating the rear of a vehicle to which a door driving unit is applied according to an embodiment of the present disclosure.

A trunk can be disposed at the rear of the vehicle. A door 2 that may divide a trunk space and an external space can be disposed at the trunk. The door 2 of FIG. 1 is an example and is a tailgate opened downwardly of the body 1.

The door 2 can be connected to a body 1. The door and the body may be provided with a lift device L to facilitate the opening and closing of the door. In this case, the lift device L may be, for example, a gas lift. As illustrated in FIG. 1, the lift device L can be disposed on each side of the door 2, but may be disposed on one side or the other side of the door 2. A link portion 3 may be disposed between the door 2 and the body 1. The link portion 3 may be disposed to be spaced apart from a door driving unit 10. The link portion 3 may be coupled to the door 2 and the body 1 to support rotation of the door 2 when the door 2 is opened and closed.

The door driving unit 10 may be disposed between the door 2 and the body 1. The door driving unit 10 can include a driving portion 13 that may electrically rotate the door 2 to open and close the door 2. The door driving unit 10 may be disposed to be spaced apart from the link portion 3 in a width direction of the door 2. With reference to FIG. 1, the width direction of the door 2 may refer to a direction, approximately parallel to the width direction of the body 1.

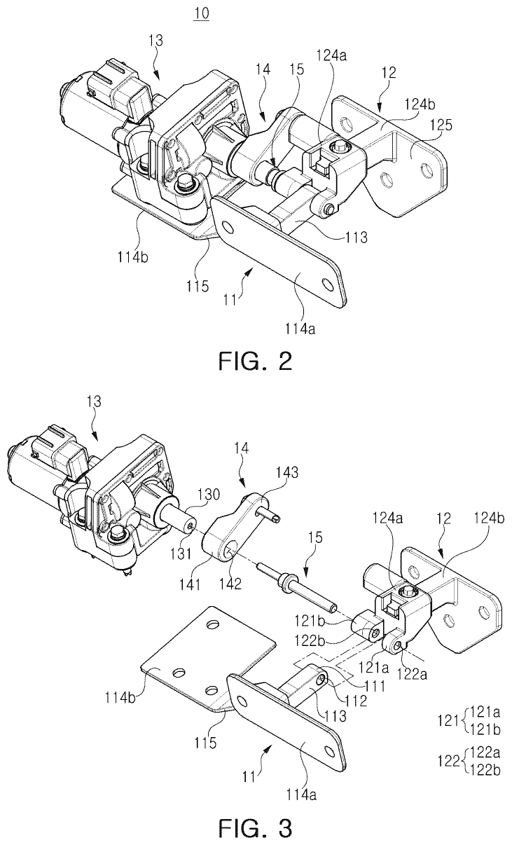

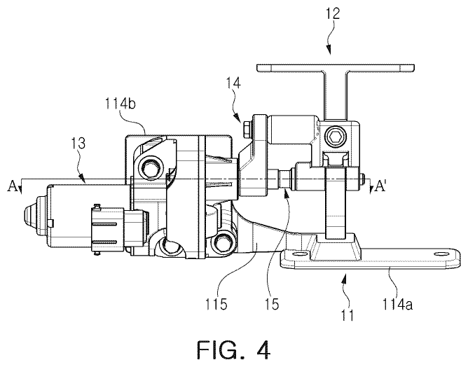

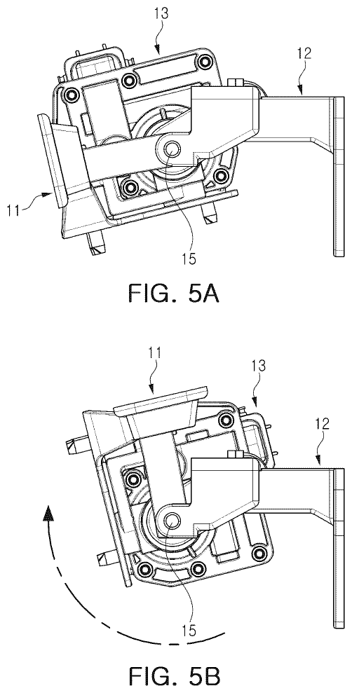

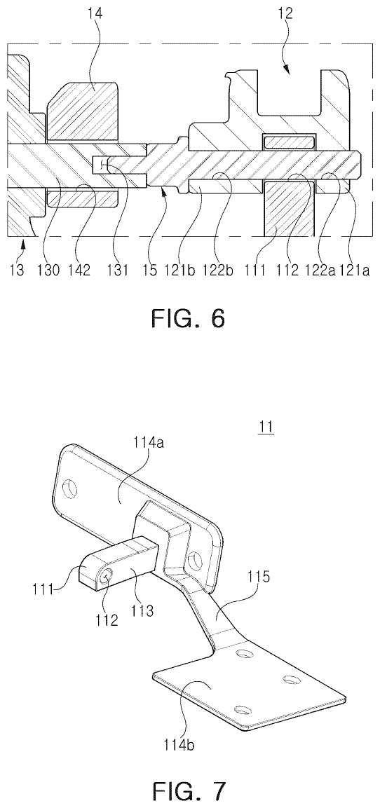

FIG. 2 is a perspective view of the door driving unit according to an embodiment of the present disclosure. FIG. 3 is an exploded view of FIG. 2. FIG. 4 is a plan view of the door driving unit according to an embodiment of the present disclosure. FIGS. 5A and 5B are diagrams illustrating an operation of a door driving unit according to an embodiment of the present disclosure. FIG. 6 is a cross-section view taken along line A-A′ of FIG. 4.

Referring to FIGS. 2 to 6, a structure of the door driving unit according to an example embodiment of the present disclosure will be described.

The door driving unit 10 may include a first bracket 11, a second bracket 12, a driving portion 13, a connecting portion 14, and a hinge portion 15.

The first bracket 11 may be disposed on one side of the door driving unit 10, and the second bracket 12 may be disposed on the other side of the door driving unit 10.

The first bracket 11 and the second bracket 12 may be coupled through the hinge portion 15. The first bracket 11 and the second bracket 12 may rotate relative to each other based on a rotational axis of the hinge portion 15.

A first coupling portion 111 including a first hole 112 can be disposed at one end of the first bracket 11. A plurality of second coupling portions 121 can include a second hole 122 and can be disposed at one end of the second bracket 12. The plurality of second coupling portions 121 can be disposed to be spaced apart from each other, and one of the plurality of second coupling portions 121 may be referred to as a 2-1 coupling portion 121a, and another of the plurality of second coupling portions 121 may be referred to as a 2-2 coupling portion 121b. A 2-1 hole 122a may be disposed in the 2-1 coupling portion 121a, and a 2-2 hole 122b may be disposed in the 2-2 coupling portion 121b.

A recess 123 may be disposed at one end of the second bracket 12. The recess 123 may be disposed between the 2-1 coupling portion 121a and the 2-2 coupling portion 121b. The first coupling portion 111 of the first bracket 11 may be disposed in the recess 123. In such configuration, the first hole 112, the 2-1 hole 122a and the 2-2 hole 122b may be aligned with each other, and the hinge portion 15 may be disposed in the aligned first hole 112, the 2-1 hole 122a, and the 2-2 hole 122b.

The driving portion 13 may be disposed on the first bracket 11. The driving portion 13 may be coupled to the first bracket 11. In detail, the driving portion 13 may be coupled to a second plate 114b of the first bracket 11. Therefore, when the first bracket 11 rotates about the hinge portion 15 with respect to the second bracket 12, the driving portion 13 may also rotate together with the first bracket 11 with respect to the second bracket 12.

The driving portion 13 may provide power for opening and closing the door 2. The driving portion 13 may use a motor as a power source. A reducer may be disposed in the driving portion 13. Through the reducer, the driving portion 13 may rotate the hinge portion 15 at a lower speed than the rotation speed of the motor and may increase the rotation torque of the hinge portion 15 to be higher than the rotation torque of the motor. One end of the hinge portion 15 may be coupled to the driving portion 13. Therefore, the hinge portion 15 may be rotated by the driving portion 13, and the first bracket 11 may be rotated relative to the second bracket 12 by the rotation of the hinge portion 15. Or, the second bracket 12 may be rotated relative to the first bracket 11 by the rotation of the hinge portion 15.

The connecting portion 14 may connect the hinge portion 15 to the second bracket 12. A third coupling portion 141 may be disposed at one end of the connecting portion 14. Therefore, one end of the connecting portion 14 may be coupled to the hinge portion 15. In the door driving unit 10, the third coupling portion 141 may be disposed to be spaced apart from the second coupling portion 121 in the direction of the rotational axis of the hinge portion 15. The third coupling portion 141 may include a third hole 142. The hinge portion 15 may be disposed to penetrate the third hole 142. The hinge portion 15 may be disposed to penetrate all of the first hole 112, the 2-1 hole 122a, the 2-2 hole 122b, and the third hole 142.

A fixing portion 143 may be disposed at the other end of the connecting portion 14. The fixing portion 143 may be coupled to the second bracket 12. In such configuration, the other end of the connecting portion 14 may be coupled to the second bracket 12 and fixed relative to the second bracket 12.

Referring to FIG. 6, a joint structure of the driving portion 13, the hinge portion 15, the first bracket 11, the second bracket 12, and the connecting portion 14 will be described in more detail.

The driving portion 13 can include a power shaft 130 transferring the rotation power of the motor. A recess 131 that can be sunken in the direction of a rotational axis of the power shaft 130 can be disposed on one side of the power shaft 130, and one end of the hinge portion 15 can be disposed in the recess 131. The recess 131 and one end of the hinge portion 15 may be coupled by a forced fit method. However, the recess 131 and one end of the hinge portion 15 can be not coupled only by the forced fit method and may also be coupled to each other by other members. An adhesive may be applied between the recess 131 and one end of the hinge portion 15. The recess 131 and one end of the hinge portion 15 may be in surface contact. Therefore, the hinge portion 15 may be coupled to the power shaft 130 and rotated by the rotation of the power shaft 130.

The first bracket 11 can be rotatably connected to the hinge portion 15. That is, the hinge portion 15 may be disposed by penetrating the first hole 112 of the first bracket 11, and a clearance can be formed between an inner circumferential surface of the first hole 112 and an outer circumferential surface of the hinge portion 15. Based on a region positioned in the first hole 112, an outer diameter of the hinge portion 15 may be formed smaller than an inner diameter of the first hole 112. Therefore, the first bracket 11 and the hinge portion 15 may rotate relative to each other, and to facilitate the relative rotation of the first bracket 11 and the hinge portion 15, a lubricant may be applied to the inner circumferential surface of the first hole 112.

The second bracket 12 and the hinge portion 15 may be coupled to each other through the 2-1 hole 122a and the 2-2 hole 122b. That is, the hinge portion 15 can be disposed through the 2-1 hole 122a and the 2-2 hole 122b of the second bracket 12, and the 2-1 hole 122a, the 2-2 hole 122b, and the hinge portion 15 may be coupled through a forced fit method. However, in such configuration, the coupling method of the 2-1 hole 122a, the 2-2 hole 122b, and the hinge portion 15 can be not limited to the forced fit method and they may also be coupled to each other through other members. The second bracket 12 can be connected to the hinge portion 15, so that the second bracket 12 may rotate together with the hinge portion 15 by the rotation of the hinge portion 15.

The connecting portion 14 can be rotatably coupled to the power shaft 130. That is, the power shaft 130 may be disposed by penetrating the third hole 142 of the connecting portion 14, and a clearance can be formed between the inner circumferential surface of the third hole 142 and the outer circumferential surface of the power shaft 130. Based on a region located in the third hole 142, the outer diameter of the power shaft 130 may be formed smaller than the inner diameter of the third hole 142. Therefore, the connecting portion 14 and the power shaft 130 may rotate relative to each other, and in order to facilitate the relative rotation of the connecting portion 14 and the power shaft 130, a lubricant may be applied to the inner circumferential surface of the third hole 142.

The connecting portion 14 may be spaced apart from the second bracket 12 and the hinge portion 15 in the axial direction to support the rotation of the hinge portion 15. That is, because the rotation of the hinge portion 15 may be supported in a plurality of positions spaced apart from each other in the rotational axis direction of the hinge portion 15, when the first bracket 11 rotates relative to the second bracket 12, the occurrence of twisting of the hinge portion 15 or twisting of the first bracket 11 and the second bracket 12 may be reduced.

FIG. 7 is a perspective view illustrating the first bracket of the door driving unit according to an embodiment of the present disclosure.

The first bracket 11 may include a first arm 113, a first plate 114a, and a second plate 114b. The first arm 113, the first plate 114a, and the second plate 114b may be formed integrally. The first arm 113 may have a cantilever structure protruding from the first plate 114a. The first coupling portion 111 including the first hole 112 described above may be disposed at one end of the first arm 113. The second plate 114b may be integrally coupled to the first plate 114a through an extension portion 115 extending from the first plate 114a. The second plate 114b may be disposed in a direction, intersecting the first plate 114a. That is, a virtual surface extending from one surface of the first plate 114a and a virtual surface extending from one surface of the second plate 114b may intersect each other.

Referring back to FIG. 1, the first plate 114a may be coupled to the body 1 or the door 2. In such configuration, the first plate 114a may be screw-coupled to the body 1 or the door 2. The first plate 114a and the body 1 or the door 2 may also be coupled by welding. The driving portion 13 may be disposed on the second plate 114b. The driving portion 13 may be coupled to the second plate 114b. The second plate 114b may also be coupled to the body 1 or the door 2. That is, the driving portion 13 may be disposed on one surface of the second plate 114b and the body 1 or the door 2 may be disposed on the other surface of the second plate 114b. The second plate 114b, the driving portion 13, and the body 1 or the door 2 may be coupled through screw coupling and/or may be coupled through welding. The first plate 114a and the second plate 114b can be spaced apart from each other in the direction of the rotational axis of the hinge portion 15 and coupled to the door. That is, because the first bracket 11 can be connected to the door 2 in a direction in which the two portions spaced apart from each other intersect each other, torsional rigidity may be improved. More specifically, the first plate 114a and the second plate 114b can be connected at an intersecting angle through the extension portion 115, and the first plate 114a and the second plate 114b can be each connected to the door of the vehicle at different angles. Therefore, when the first bracket 11 and the second bracket 12 are rotated relative to each other by the driving portion and the door can be opened and closed therethrough, the torsional load acting on the first bracket 11 can be distributed to the first plate 114a, the second plate 114b, and the extension portion 115 at different angles or directions. The durability of the first bracket 11 may be secured accordingly.

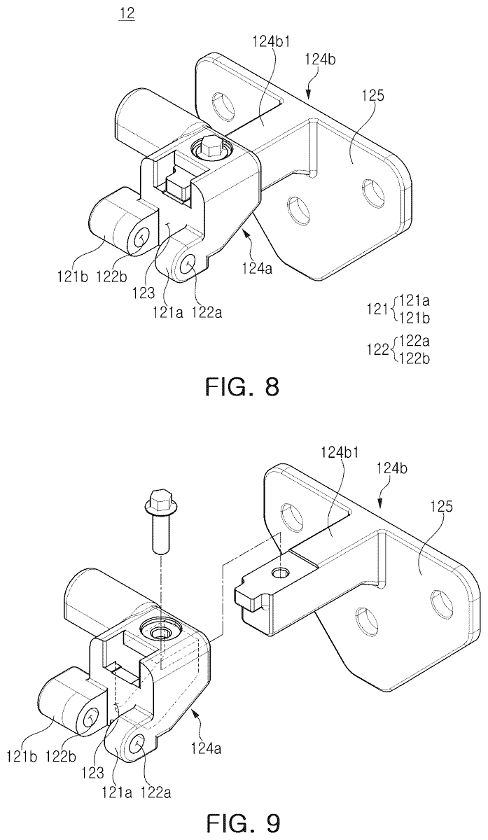

FIG. 8 is a perspective view illustrating the second bracket of the door driving unit according to an embodiment of the present disclosure. FIG. 9 is an exploded view illustrating the second bracket of FIG. 8.

The second bracket 12 may include a first body portion 124a and a second body portion 124b. Referring to FIGS. 8 and 9, the first body portion 124a and the second body portion 124b are illustrated as being formed as independent members and coupled together, but they may also be formed integrally.

The first body portion 124a may be coupled to the first bracket 11. That is, the 2-1 coupling portion 121a and 2-2 coupling portion 121b may be disposed on the first body portion 124a. The 2-1 coupling portion 121a and the 2-2 coupling portion 121b may be spaced apart from each other in a direction, parallel to the axial direction of the hinge portion 15. The recess 123 described above can be disposed between the 2-1 coupling portion 121a and the 2-2 coupling portion 121b, and through this structure, the 2-1 coupling portion 121a, the 2-2 coupling portion 121b, and the recess 123 may form a concavo-convex structure. The first coupling portion 111 of the first arm 113 described above can be disposed in the recess 123, and the hinge portion 15 may connect the first coupling portion 111, the 2-1 coupling portion 121a, and the 2-2 coupling portion 121b.

The second body portion 124b may include an arm. The arm of the second body portion 124b may be referred to as a second arm 124b1 to be distinguished from the first arm 113 of the first bracket 11. One end of the second arm 124b1 may be coupled to the first body portion 124a. One end of the second arm 124b1 may be fixed to the first body portion 124a. A plate may be disposed at the other end of the second arm 124b1. The plate of the second arm 124b1 may be referred to as a third plate 125 to be distinguished from the first plate 114a and the second plate 114b of the first bracket 11.

The third plate 125 may be coupled to the body 1 or the door 2. The third plate 125 may be coupled to the body 1 or the door 2 through screw coupling and may be connected to the body 1 or the door 2 through welding.

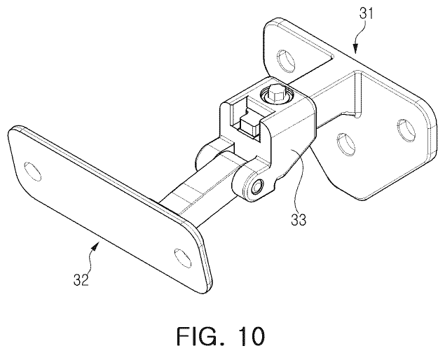

FIG. 10 is a perspective view illustrating a link portion that may be used with the door driving unit according to an embodiment of the present disclosure.

Referring to FIG. 1, the link portion 3 may be disposed between the door 2 and the body 1. The link portion 3 may connect the door 2 and the body 1. The link portion 3 can include a first member 31 and a second member 32, and these members can be pivotably coupled.

Specifically, the first member 31 can be rotatably coupled to the second member 32. The first member 31 may rotate relative to the second member 32, and conversely, the second member 32 may rotate relative to the first member 31. The first member 31 may be coupled to the body 1, and the second member 32 may be coupled to the door 2. The first member 31 and the second member 32 may also be coupled to each other in the opposite structure. A coupling portion 33 of the first member 31 and the second member 32 can act as the center of rotation of the door 2 to be opened and closed, thereby supporting smooth opening and closing of the door 2.

According to an embodiment of the present disclosure, the first bracket 11 of the door driving unit 10 can be coupled to the door 2 in a plurality of portions to open and close the door 2, and torsional deformation of the door driving unit 10 can be minimized when the door 2 is opened and closed through the connecting portion 14 supporting the rotation of the first bracket 11 and the second bracket 12. According to an embodiment of the present disclosure, the structure in which the driving portion 13 and the hinge portion 15 of the door driving unit 10 are disposed between the door 2 and the body 1 can have the advantage of securing a wide loading space.

The door driving unit according to an embodiment of the present disclosure and a vehicle including the same can provide various advantages by improving the opening and closing structure of the trunk door. By optimizing the structure and arrangement method of the door driving unit, interference with the body may be minimized when the door is opened, thereby increasing the opening angle of the door and improving usability. The driving portion of the door driving unit can be disposed outside the trunk loading space or designed with a structure increasing space efficiency so that the loading space inside the trunk may be utilized to the maximum. This can allow more luggage to be loaded in the trunk.

The structure of an embodiment of the present disclosure can increase the operational stability of the door driving unit, thereby reducing problems that may arise when opening and closing the door, which can provide the advantage of extending the lifespan of the electric door and reducing maintenance costs. An embodiment of the present disclosure can provide a structure that may be applied to both the front and rear trunks of a modularized electric vehicle, so that it may be applied to various vehicle designs. Accordingly, using an embodiment of the present disclosure, the degree of design freedom in vehicle design may be increased and the production efficiency of the vehicle may be increased.

While example embodiments have been shown and described above, it can be apparent to those skilled in the art that modifications and variations can be made without departing from the scopes of the present disclosure as defined by the appended claims.

What is claimed is:

1. A door driving system comprising:
a first bracket;
a second bracket;
a hinge portion connecting the first bracket to the second bracket;
a driving portion disposed on the first bracket and coupled to the hinge portion; and
a connecting portion having a first connecting-portion side coupled to the second bracket and a second connecting-portion side connected to the driving portion in a configuration to support rotation of the first bracket.

2. The system of claim 1, wherein the first bracket comprises:
a first plate;
a second plate connected to the second bracket through the hinge portion; and
an extension portion connecting the first plate to the second plate, wherein the driving portion is coupled to the second plate.

3. The system of claim 2, wherein the first plate and the second plate are disposed in an intersecting direction.

4. The system of claim 1, wherein the first bracket is provided with a first coupling portion connected to the hinge portion, and the first coupling portion is disposed to be spaced apart from the connecting portion in a direction of a rotational axis of the hinge portion.

5. The system of claim 1, wherein the driving portion comprises a power shaft configured to transmit rotation power,
wherein a first hinge-portion side of the hinge portion is coupled to the power shaft and a second hinge-portion side of the hinge portion is coupled to the second bracket, and
wherein the second bracket is configured to rotate by rotation of the hinge portion.

6. The system of claim 5, wherein the connecting portion is provided with a hole through which the power shaft passes, and a clearance is formed between an inner circumferential surface of the hole and an outer circumferential surface of the power shaft.

7. The system of claim 5, wherein the power shaft and the hinge portion are forcedly fitted to be fixedly coupled.

8. The system of claim 7, wherein an adhesive is applied between the power shaft and the hinge portion.

9. A vehicle comprising:
a body;
a door disposed on the body; and
a door driving system configured to drive the door, wherein the door driving system includes:
a first bracket,
a second bracket,
a hinge portion connecting the first bracket to the second bracket,
a driving portion disposed on the first bracket and coupled to the hinge portion, and
a connecting portion having a first side coupled to the second bracket and a second side connected with the driving portion in a configuration to support rotation of the first bracket.

10. The vehicle of claim 9, wherein the first bracket is coupled to the door, and wherein the second bracket is coupled to the body.

11. The vehicle of claim 9, wherein the first bracket comprises:
a first plate;
a second plate connected to the second bracket through the hinge portion; and
an extension portion connecting the first plate to the second plate, wherein the first plate and the second plate are spaced apart in a direction of a rotational axis of the hinge portion and are coupled to the door.

12. The vehicle of claim 11, wherein the first plate and the second plate are disposed in an intersecting direction and are each coupled to the door.

13. The vehicle of claim 9, further comprising a link portion connecting the body and the door, wherein the link portion is disposed to be spaced apart from the door driving system in a width direction of the body.

14. A door drive system comprising:
a first bracket;
a second bracket;
a hinge shaft connecting the first bracket to the second bracket at a hinge coupling location such that the first bracket can pivot relative to the second bracket about a hinge axis of the hinge shaft;
a drive portion disposed on the first bracket and coupled to the hinge shaft, wherein the drive portion is configured to drive a pivotal movement of the first bracket relative to the second bracket via the hinge shaft; and
a connection portion having a first connection-portion side fixedly coupled to the second bracket and a second connection-portion side pivotably coupled to hinge shaft, wherein the connection portion is disposed between the drive portion and the hinge coupling location.

15. The system of claim 14, wherein a main body portion of the connection portion is spaced apart from the hinge coupling location.

16. The system of claim 14, wherein the first bracket comprises:
a first plate;
a second plate; and
an extension portion connecting the first plate to the second plate, wherein the drive portion is coupled to the second plate, wherein the second plate is also coupled to the first plate via the drive portion and the hinge shaft, and wherein the first bracket is pivotably coupled to the hinge shaft.

17. The system of claim 16, wherein the first plate and the second plate are disposed in an intersecting direction.

18. The system of claim 14, wherein the drive portion comprises a power shaft configured to transmit rotation power to the hinge shaft,
wherein a first hinge-shaft side of the hinge shaft is fixedly coupled to the power shaft and a second hinge-shaft side of the hinge shaft is fixedly coupled to the second bracket,
wherein the second bracket is configured to pivot by rotation of the hinge shaft, and
wherein the second connection-portion side is pivotably coupled to hinge shaft via the power shaft.

19. The system of claim 18, wherein the connection portion has a hole through which the power shaft passes, and a clearance is formed between an inner circumferential surface of the hole and an outer circumferential surface of the power shaft.

20. The system of claim 19, wherein the power shaft and the hinge shaft are forcedly fitted to be fixedly coupled.
